(19) United States
(12) Patent Application Publication
(10) Pub. No.: US 2014/0166388 A1
(43) Pub. Date: Jun. 19, 2014

(54) EAR TIP

(71) Applicant: Bill Yang, Taipei City (TW)

(72) Inventor: Bill Yang, Taipei City (TW)

(73) Assignee: Cotron Corporation, Taipei City (TW)

(21) Appl. No.: 13/776,740

(22) Filed: Feb. 26, 2013

(30) Foreign Application Priority Data
Dec. 17, 2012 (TW) 101147990

(51) Int. Cl. H04R 25/00

(52) U.S. Cl. CPC H04R 25/652
USPC 181/135

(57) ABSTRACT

An ear tip including a tube portion and an outer-umbrella portion is provided. The tube portion has a first end and a second end opposite to the first end, so that a sound output tube of an insert-type earphone may be inserted into the tube portion from the first end of the tube portion. Besides, when the ear tip is placed into an ear canal of a user, the second end of the tube portion enters the ear canal at first. The outer-umbrella portion extends from an outer surface of the tube portion and surrounds an axial direction of the tube portion. The second end of the tube portion protrudes from a top of the outer-umbrella portion.

### CROSS-REFERENCE TO RELATED APPLICATION

This application claims the priority benefit of Taiwan application serial no. 101147990, filed on Dec. 17, 2012. The entirety of the above-mentioned patent application is hereby incorporated by reference herein and made a part of this specification.

### BACKGROUND OF THE INVENTION

1. Field of the Invention

The invention relates to an ear tip and particularly relates to an ear tip of an insert-type earphone.

2. Description of Related Art

With the rapid progress in science and technology, all electronic products have been developed towards light, handy and miniaturized designs. People may use miniaturized electronic products, such as radios or walkmans, anytime and anywhere. Moreover, personal digital products including common MP3 walkmans, cell phones, personal digital assistants (PDAs), or notebooks has increasingly become popular and indispensable in our daily lives. In addition, cell phones integrated with functions of both radio and MP3 have been developed.

For each of those aforementioned electronic products, in order to allow a user to listen to the audio information provided by the electronic products without disturbing other people around, an earphone has become a necessary accessory to the electronic products. Moreover, the earphone also provides a listener with favorable audio transmission quality, such that the listener is able to clearly hear and understand contents of the audio information. In contrast to unclear audio transmission through the air (especially when the listener is moving, e.g., doing exercises, driving, intensely moving around, or being in a noisy environment), the audio transmission through the earphone is not affected by the surroundings.

At present, the audio output end of common earphones is miniaturized and mounted with an ear tip. Thereby, the audio output end may be placed in the deep ear canal, and elastic deformation of the ear tip allows the ear tip to be adapted to different canal contours of users. The ear tip of said earphones seals the ear canal of the user, so as to block external sound and thereby enhance sound quality.

FIG. 1 is a schematic view of placing a common earphone with ear tips into an ear canal of a user. With reference to FIG. 1, the ear canal 10 of human beings has two 90-degree bent portions approximately. The common ear tips 20 frequently have umbrella portions 22 at the foremost ends thereof As shown in FIG. 1, due to the bulky volume, the umbrella portion 22 of the ear tip 20 pushes against the wall of the first 90-degree bent portion of the ear canal 10 and is thus unable to reach the deep ear canal 10. Since the ear tip 20 is placed at the entrance of the ear canal 10, the user may feel anxious about the earphone 30 falling out of the ear canal 10. Additionally, the air space between the speaker vibration membrane of the earphone 30 and the eardrum in the deep ear canal 10 is excessively large, thus posing a negative impact on the high frequency response.

FIG. 2 is a schematic view illustrating a conventional triple-flange ear tip. With reference to FIG. 2, a front end of the triple-flange ear tip 40 is relatively small and may be placed in the deep ear canal. The three umbrella portions 42 of the triple-flange ear tip 40, however, are apt to encounter an issue of excessive size. Although the triple-flange ear tip 40 with the three umbrella portions 42 may have great structural strength, the triple-flange ear tip 40 is not apt to be bent.

FIG. 3 is a schematic view illustrating another conventional ear tip. With reference to FIG. 3, the ear tip 50 has a tube portion 52, and grooves 54 are configured on a surface of the tube portion 52, such that the ear tip 50, when entering an ear canal of human beings, may be bent at the grooves 54 according to the shape of the ear canal of the user. However, similar to the ear tip shown in FIG. 1, the ear tip described herein may still have the oversized umbrella portion 56 and cannot easily go deep into the ear canal of human beings.

FIG. 4 is a schematic view illustrating the ear tip disclosed in JP Patent Publication 2007-37187. With reference to FIG. 4, a sound output tube 72 of an earphone 70 is directly designed to have a bent shape, such that the ear tip 60 of the earphone 70 is able to fit the shape of an ear canal. Nevertheless, the ear canals of users may have different shapes; even though the sound output tube 72 is covered by a flexible ear tip 60, the hard and stiff texture of the sound output tube 72 often discomforts the user when the ear tip 60 is placed in the deep ear canal.

### SUMMARY OF THE INVENTION

The invention is directed to an ear tip for resolving an issue of unfavorable audio quality caused by the difficulty in placing the ear tip deep into an ear canal of a user.

In an embodiment of the invention, an ear tip including a tube portion and an outer-umbrella portion is provided. The tube portion has a first end and a second end opposite to the first end, so that a sound output tube of an insert-type earphone may be inserted into the tube portion from the first end of the tube portion. Besides, when the ear tip is placed into an ear canal of a user, the second end of the tube portion enters the ear canal at first. The outer-umbrella portion extends from an outer surface of the tube portion and surrounds an axial direction of the tube portion. The second end of the tube portion protrudes from a top of the outer-umbrella portion.

According to an embodiment of the invention, the tube portion further has a first groove in a ring shape, and the first groove is located between the outer-umbrella portion and the second end of the tube portion. The tube portion may further have a plurality of second grooves in a ring shape.

According to an embodiment of the invention, the outer-umbrella portion extends from a middle section of the tube portion. The tube portion further has a first groove in a ring shape, the first groove is located between the outer-umbrella portion and the second end of the tube portion, and the first groove adjoins the outer-umbrella portion.

According to an embodiment of the invention, the outer-umbrella portion extends from the first end of the tube portion toward a direction away from the second end of the tube portion.

According to an embodiment of the invention, a cross-section of the tube portion perpendicular to the axial direction of the tube portion has an elliptic shape.

According to an embodiment of the invention, a diameter of the tube portion around the second end gradually decreases in a direction toward the second end of the tube portion.

According to an embodiment of the invention, the ear tip is integrally formed.

According to an embodiment of the invention, a material of the ear tip is silicone.

In view of the above, parts of the tube portion of the ear tip in front of the outer-umbrella portion are suitable for being placed deep into the ear canal of the user, so as to provide favorable audio quality and ensure comfort of the user who wears the ear tip described herein.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic view of placing a common earphone with ear tips into an ear canal of a user.

FIG. 2 is a schematic view illustrating a conventional triple-flange ear tip.

FIG. 3 is a schematic view illustrating another conventional ear tip.

FIG. 4 is a schematic view illustrating the ear tip disclosed in JP Patent Publication 2007-37187.

FIG. 5 is a schematic cross-sectional view of assembling an ear tip to an earphone according to an embodiment of the invention.

FIG. 6 shows a frequency response of an earphone applying the ear tip depicted in FIG. 5 and a frequency response of a conventional earphone.

FIG. 7 is a cross-sectional view illustrating a tube portion of the ear tip shown in FIG. 5.

FIG. 8 to FIG. 10 are schematic cross-sectional views illustrating an ear tip according to three other embodiments of the invention.

### DETAILED DESCRIPTION OF DISCLOSED EMBODIMENTS

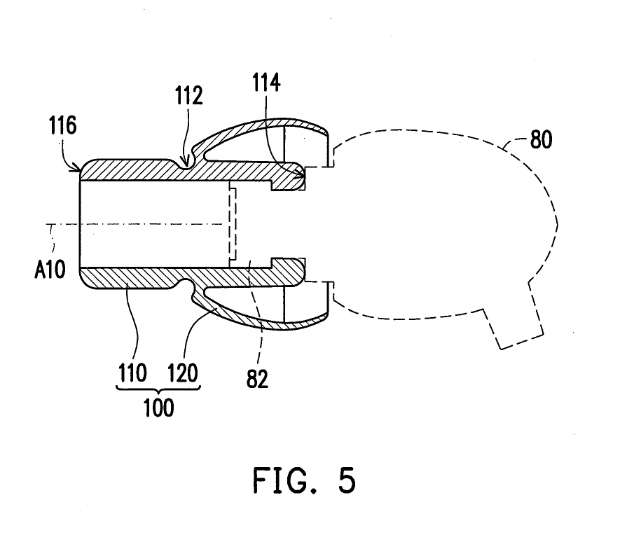

FIG. 5 is a schematic cross-sectional view of assembling an ear tip to an earphone according to an embodiment of the invention. With reference to FIG. 5, the ear tip 100 described in the present embodiment includes a tube portion 110 and an outer-umbrella portion 120. The tube portion 110 has a first end 114 and a second end 116 opposite to the first end 114. The tube portion 112 further has a first groove 112 in a ring shape. Here, the first ring-shaped groove 112 refers to the first groove 112 that surrounds the tube portion 110. A thickness of the wall of the first groove 112 of the tube portion 110 is less than a thickness of the wall of other parts of the tube portion 110. When the ear tip 100 is assembled to the insert-type earphone 80, a sound output tube 82 of the insert-type earphone 80 is inserted into the tube portion 114 from the first end 110. When the ear tip 100 is placed into an ear canal (shown in FIG. 1) of a user, the second end 116 of the tube portion 110 enters the ear canal at first. The outer-umbrella portion 120 extends from an outer surface of the tube portion 110 and surrounds an axial direction A10 of the tube portion 110. The second end 116 of the tube portion 110 protrudes from the top of the outer-umbrella portion 120. That is, at least parts of the tube portion 110 extend away from the outer-umbrella portion 120, and the second end 116 is located at said parts of the tube portion 110.

When the ear tip 100 described in the present embodiment is placed into the ear canal (shown in FIG. 1), a dimension of parts of the tube portion 110 protruding from the top of the outer-umbrella portion 120 is smaller than a dimension of the outer-umbrella portion 120. Therefore, the outer-umbrella portion 120 does not hinder when the second end 116 of the tube portion 110 enters the deep ear canal, and the tube portion 110 may easily go deep into the ear canal and even pass the bent portion of the ear canal. Thereby, favorable audio quality may be guaranteed, the ear tip 100 is less likely to fall out of the ear canal, and the user wearing the ear tips 100 may feel secure and comfortable.

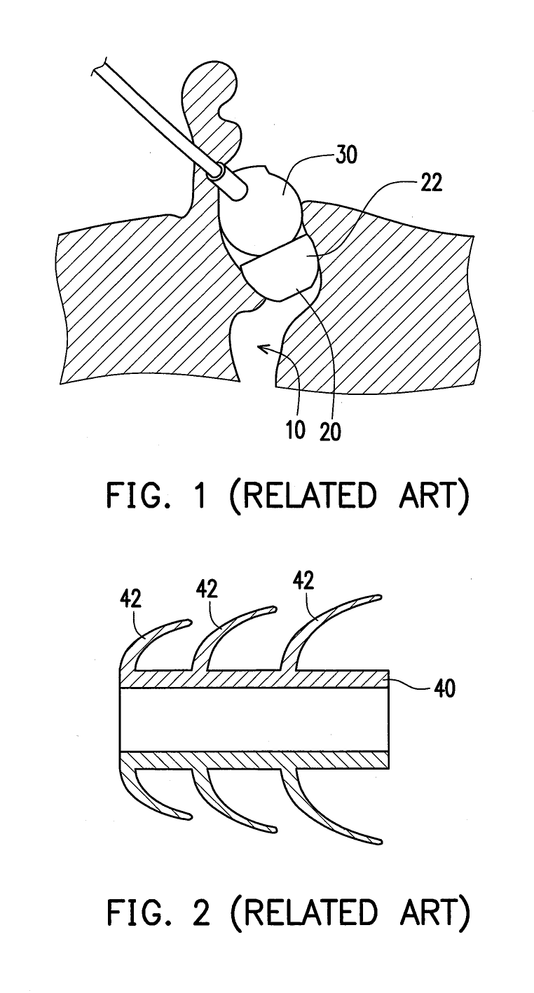

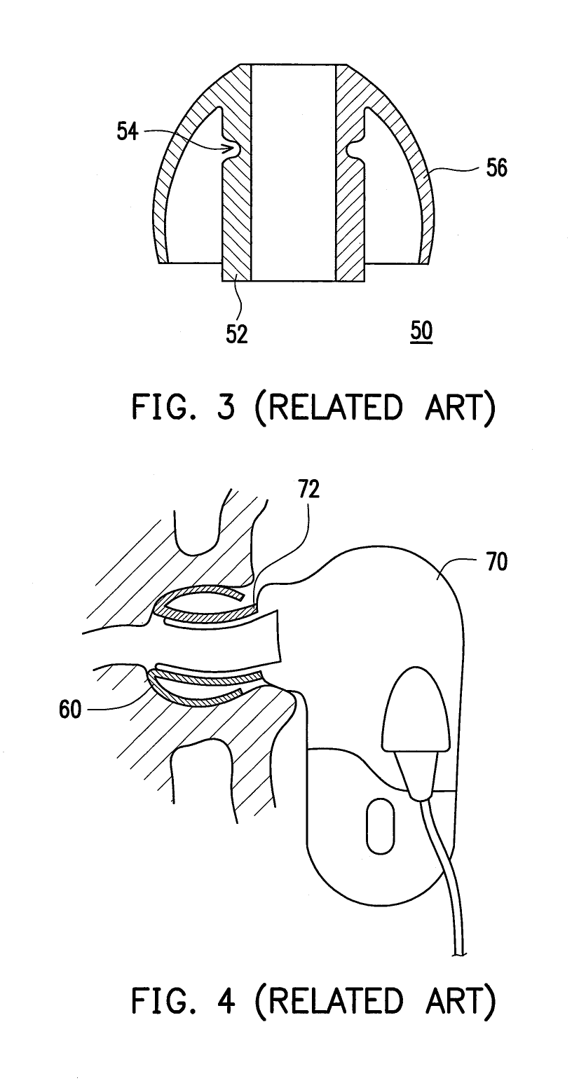

According to the present embodiment, the tube portion 110 of the ear tip 100 further has the first groove 112 in the ring shape, and the first groove 112 is located between the outer-umbrella portion 120 and the second end 116 of the tube portion 110. When the second end 116 travels to the bent portion of the ear canal, stress is concentrated at the first groove 112, such that the tube portion 110 is bent at the first groove 112. Thereby, parts of the tube portion 110 between the first groove 112 and the second end 116 may easily pass the bent portion of the ear canal and go deep into the ear canal. In addition, the outer-umbrella portion 120 is located between the first groove 112 and the first end 114 and thus does not hinder when the second end 116 of the tube portion 110 enters the deep ear canal. Besides, in the present embodiment, the tube portion 110 of the ear tip 100 first enters the ear canal. Compared to the conventional triple-flange ear tip 40 having the three umbrella portions 42 as shown in FIG. 2, the ear tip 100 described herein may go deeper in the ear canal.

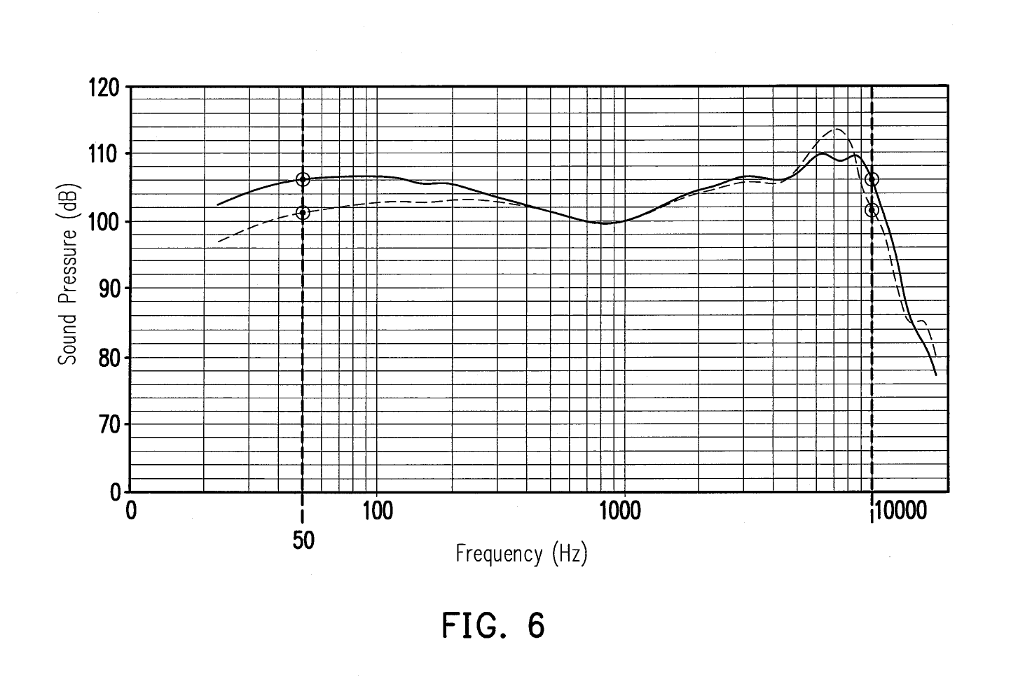

FIG. 6 shows a frequency response of an earphone applying the ear tips depicted in FIG. 5 and a frequency response of a conventional earphone. With reference to FIG. 6, a frequency response curve of a earphone 80 applying the ear tip 100 depicted in FIG. 5 is a solid curve, while a frequency response curve of a conventional earphone is a dotted curve. As shown in FIG. 6, the ear tip 100 is able to enter the deep ear canal, and thus the frequency response of the earphone 80 equipped with the ear tip 100 is greater than that of the conventional earphone, regardless of whether the frequency is low (e.g., about 50 Hz) or high (e.g., about 10000 Hz). It is thus evidenced that the effects achieved by the ear tip 100 described herein are greater than those accomplished by the conventional ear tip.

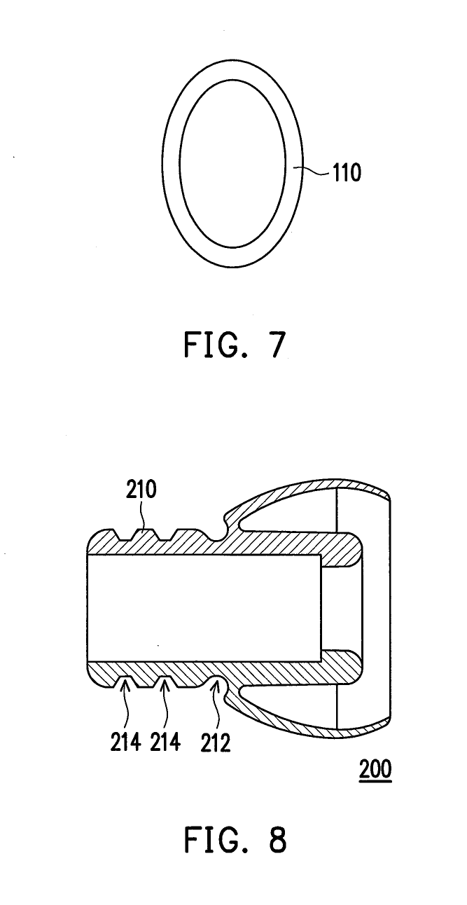

The ear tip 100 described in the present embodiment may be integrally formed. Namely, there is no bonding structure between the tube portion 110 and the outer-umbrella portion 120, and hence the issue of unfavorable bonding yield does not occur. From another perspective, the ear tip 100 may be made of silicone or any other appropriate material, such that the ear tip 100 is allowed to be elastically deformed and fit various shapes of the ear canals of different users, and that the users wearing the ear tips 100 may feel secure and comfortable. According to the present embodiment, the outer-umbrella portion 120 extends from a middle section of the tube portion 110, and the first groove 112 adjoins the outer-umbrella portion 120. That is, parts of the tube portion 110 in front of the outer-umbrella portion 120 are suitable for being placed deep into the ear canal of the user. Moreover, a cross-section of the ear canal is often in an elliptic shape; accordingly, in the present embodiment, a cross-section of the tube portion 110 perpendicular to the axial direction A10 of the tube portion 110 may be designed to have an elliptic shape shown in FIG. 7, so that the tube portion 110 may easily go deep into the ear canal without discomforting the user.

Other embodiments are given hereinafter for explanation. Note that reference numbers and some descriptions provided in the previous embodiment are also applied in the following embodiment. The same reference numbers represent the same or similar components in these embodiments, and repetitive descriptions are omitted. The omitted descriptions may be referred to as those described in the previous embodiments.

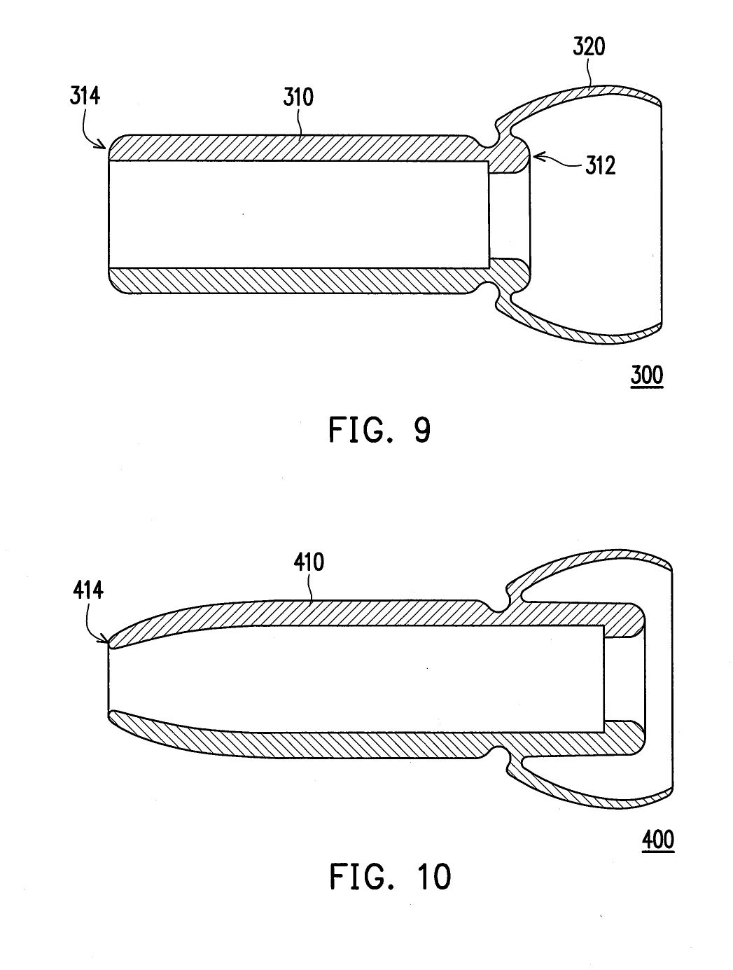

FIG. 8 to FIG. 10 are schematic cross-sectional views illustrating an ear tip according to three other embodiments of the invention. With reference to FIG. 8, the ear tip 200 described in the present embodiment includes a tube portion 210, and the tube portion 210 not only has the first groove 212 in a ring shape but also has a plurality of second grooves 214 in a ring shape. The configuration of the second grooves 214 allows the tube portion 210 to be bent more easily. With reference to FIG. 9, according to the present embodiment, the outer-umbrella portion 320 of the ear tip 300 extends from the first end 312 of the tube portion 310 toward a direction away from the second end 314 of the tube portion 310. Thereby, almost the entire tube portion 310 is located in front of the outer-umbrella portion 320 and is able to go deep into the ear canal. With reference to FIG. 10, according to the present embodiment, in the ear tip 400, a diameter of the tube portion 410 around the second end 414 gradually decreases in a direction toward the second end 414 of the tube portion 410. Owing to the small diameter of the second end 414, the tube portion 410 is capable of entering the deep ear canal in an accurate and smooth manner. Therefore, when the user is wearing the ear tip 400, possible discomfort caused by the tube portion 410 of the ear tip 400 touching the ear canal of the user may be prevented.

To sum up, parts of the tube portion of the ear tip in front of the outer-umbrella portion are suitable for being moved along and placed deep into an ear canal of a user. Besides, if the tube portion is equipped with the first groove, the tube portion is apt to be bent, and thereby the ear tip may be bent according to the shape of the ear canal of the user and thus go deep into the ear canal. Thereby, favorable audio quality may be guaranteed, the ear tip is less likely to fall out of the ear canal, and the user wearing the ear tips may feel secure and comfortable.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

1. An ear tip comprising:
a tube portion having a first end and a second end opposite to the first end, wherein a sound output tube of an insert-type earphone is inserted into the tube portion from the first end of the tube portion, and when the ear tip is placed into an ear canal of a user, the second end of the tube portion enters the ear canal at first; and.
an outer-umbrella portion extending from an outer surface of the tube portion and surrounding an axial direction of the tube portion, the second end of the tube portion protruding from a top of the outer-umbrella portion, wherein no another outer-umbrella portion is formed on the second end of the tube portion.

2. The ear tip as recited in claim 1, wherein the tube portion further has a first groove in a ring shape, and the first groove is located between the outer-umbrella portion and the second end of the tube portion.

3. The ear tip as recited in claim 2, wherein the tube portion further has a plurality of second grooves in a ring shape.

4. The ear tip as recited in claim 1, wherein the outer-umbrella portion extends from a middle section of the tube portion.

5. The ear tip as recited in claim 4, wherein the tube portion further has a first groove in a ring shape, the first groove is located between the outer-umbrella portion and the second end of the tube portion, and the first groove adjoins the outer-umbrella portion.

6. The ear tip as recited in claim 1, wherein the outer-umbrella portion extends from the first end of the tube portion toward a direction away from the second end of the tube portion.

7. The ear tip as recited in claim 1, wherein a cross-section of the tube portion perpendicular to the axial direction of the tube portion has an elliptic shape.

8. The ear tip as recited in claim 1, wherein a diameter of the tube portion around the second end gradually decreases in a direction toward the second end of the tube portion.

9. The ear tip as recited in claim 1 is integrally formed.

10. The ear tip as recited in claim 9, wherein a material of the ear tip is silicone.
